(19) United States
(12) Patent Application Publication
(10) Pub. No.: US 2023/0377171 A1
(43) Pub. Date: Nov. 23, 2023

(54) SYSTEM AND METHOD FOR IMAGE SEGMENTATION FOR DETECTING THE LOCATION OF A JOINT CENTER

(71) Applicant: DARI Motion, Inc., Grand Island, NE (US)

(72) Inventors: Nils Hasler, Saarbrucken (DE); Michal Richter, Prague (CZ)

(21) Appl. No.: 18/320,886

(22) Filed: May 19, 2023

Related U.S. Application Data
(60) Provisional application No. 63/344,426, filed on May 20, 2022.

(51) Int. Cl. G06T 7/215; G06T 7/11; G06T 7/70

(52) U.S. Cl. CPC G06T 7/215; G06T 7/11; G06T 7/70; G06T 2207/20084; G06T 2207/20081; G06T 2207/30196; G06T 2200/04

(57) ABSTRACT

The disclosure is related to methods and systems for digital image segmentation for objectively identifying joint center locations. In one embodiment, the methods and system disclosed herein use automated methods to capture and process digital images and motion data to identify, validate, and apply segmentation algorithms trained for one or more targeted anatomical structures of a human subject.

### CROSS-REFERENCE TO RELATED APPLICATIONS

This application claims priority to U.S. Provisional Patent Application Ser. No. 63/344,426, filed on May 20, 2022, to Nils Hasler et. al., entitled “System and Method for Detecting Location of a Joint Center,” currently pending, the entire disclosure of which is incorporated herein by reference.

The entire disclosures of U.S. Pat. No. 8,527,217, issued on Sep. 3, 2013, to Patrick Moodie, entitled “Apparatus and Method for Physical Evaluation,” and U.S. Pat. No. 9,619,704, issued on Apr. 11, 2017, to Nils Hasler et al., entitled “Fast Articulated Motion Tracking,” are also incorporated herein by reference.

### BACKGROUND OF INVENTION

The field of the present invention relates generally to systems and methods for image segmentation, processing, and analysis to objectively determine joint and limb centers.

Three-dimensional (3D) motion capture image segmentation is an important technology that supports clinical motion capture workflow, including data collection, therapy planning, intervention, and progressive/longitudinal tracking. 3D motion capture segmentation refers to the detection of boundaries of structures, such as arms, hands, legs, feet, torso, and head of a human subject. Existing applications for automatic 3D motion capture segmentation are not without deficiencies, specifically due to low contrast, image noise, occlusions, or other imaging ambiguities. Due to the vast range of applications to which body part segmentation can be applied, it is challenging to develop a general body segmentation method that works robustly for markerless motion capture. Without a more reliable and repeatable way to segment the joint center locations of a human body, clinical applications for longitudinal tracking and database normative referencing are not possible.

Therefore, a need exists for a 3D motion capture solution that is able to more accurately and reliably locate segment joint center locations of the human body.

### BRIEF SUMMARY OF THE INVENTION

The present invention is directed generally to systems and methods for analyzing and processing image data to objectively evaluate digital image segmentation of 3D motion capture markerless visual hulls. The present invention utilizes advanced techniques for image processing and boundary detection, including but not limited to digital segmentation of images using iteratively trained advanced training modules to evaluate targeted anatomical structures in the human body during 3D motion capture to objectively, accurately, and efficiently identify joint center locations. The system and method are capable of locating various types of joints and joint centers, including but not limited to: ball and socket joints, hinge joints, saddle joints, plane joints, pivot joints and ellipsoid joints. More specifically, visual hull segmentation methods can be used to evaluate joints and joint centers including, but not limited to the knees, hips, ankles, shoulders, elbows, wrists, spine, and neck joints, as well as articulation joints of the feet and hands.

According to a first embodiment, an image segmentation method for analyzing digital image data and detecting a location of a joint center of a human subject can include capturing a digital image using an image capture device. In some embodiments, the digital image is a video. In some embodiments, the image capture device is a 3D markerless motion capture device. The method can further include detecting a visual hull segmentation of the digital image, the visual hull segmentation including one or more proxy spheres. In some embodiments, the proxy spheres represent body segments of the human subject. The method can further include selecting an initial segmentation algorithm based on a context of the visual hull segmentation and identifying a set of initial joint center coordinates using the initial segmentation algorithm. In some embodiments, the set of initial joint center coordinates are determined based on the visual hull segmentation. The method can also include capturing a functional movement of the human subject and applying a deep neural network algorithm to select an updated segmentation algorithm. In some embodiments, the deep neural network algorithm utilizes the functional movement of the human subject and at least one visual hull segmentation algorithm to select the updated segmentation algorithm. The method can further include generating an updated segmentation model based on the set of updated joint center coordinates. In some embodiments, the set of updated joint center coordinates of the human subject identified using the updated segmentation model are an improved representation of the human subject's joint center locations compared to the set of initial joint center coordinates of the human subject identified using the initial segmentation algorithm. In some embodiments, the method can further include the steps of training a segmentation algorithm based on a target anatomical structure and segmenting the target anatomical structure of the human subject using the segmentation algorithm trained for the target anatomical structure.

According to a second embodiment, an image segmentation method for detecting a location of a joint center of a human subject includes obtaining a digital image from an image capture device. In some embodiments, the digital image is a 3D image. In some embodiments, the image capture device is a markerless motion capture device. The method can further include detecting a visual hull segmentation of the digital image, wherein the visual hull segmentation includes one or more proxy spheres. In some embodiments, the proxy spheres represent body segments of the human subject. The method can further include selecting an initial segmentation algorithm using baseline emphasis guidelines based on a segmentation context of the visual hull segmentation. The method can further include identifying a set of initial joint center coordinates using the initial segmentation algorithm. In some embodiments, the set of initial joint center coordinates are determined based on the visual hull segmentation. The method can further include generating an initial segmentation model based on the initial joint center coordinates. The method can also include obtaining functional movement of the human subject and applying a deep neural network algorithm based on the functional movement. The method can further include validating the deep neural network algorithm and updating the baseline emphasis guidelines based on the validating step. In some embodiments, the validating step can further include receiving image data from the image capture device, calculating segmentations from the initial segmentation algorithm to establish the baseline emphasis guidelines, creating training data including a digital library of human subjects and associated functional movement data with skeletal tracking, and confirming the deep neural network algorithm selects a segmentation algorithm that accurately identifies a joint center localization. The method can further include saving the updated emphasis guidelines and selecting an updated segmentation algorithm using the updated emphasis guidelines. The method can further include identifying a set of updated joint center coordinates using the updated segmentation algorithm and the deep neural network algorithm. The method can also include generating an updated segmentation model based on the set of updated joint center coordinates. In some embodiments, the updated segmentation model can identify distinct body segments of the human subject.

According to a third embodiment, a method for detecting a location of a joint center can include the steps of obtaining a digital image of a human subject from an image capture device and detecting a visual hull segmentation of the human subject, the visual hull segmentation including one or more proxy spheres. In some embodiments, the proxy spheres may represent body segments of the human subject. The method can further include the step of calculating an initial segmentation algorithm of the human subject, the initial segmentation algorithm including a set of initial joint center coordinates of the human subject. In some embodiments, the set of initial joint center coordinates may be determined based on the visual hull segmentation. The method can further include the steps of obtaining a functional movement of the human subject from the image capture device and utilizing a deep neural network algorithm to calculate an updated segmentation algorithm of the human subject, the updated segmentation model including a set of updated joint center coordinates of the human subject. In some embodiments, the deep neural network algorithm utilizes the functional movement of the human subject and a visual hull segmentation algorithm to calculate the updated segmentation algorithm of the human subject. In some embodiments, the method may further include the steps of generating an initial segmentation model of the human subject based on the initial joint center coordinates of the human subject and generating an updated segmentation model of the human subject based on the updated joint center coordinates of the human subject.

This Summary is provided to introduce a selection of concepts in a simplified form that is further described below in the Detailed Description. This Summary is not intended to identify key features or essential features of the claimed subject matter, nor is it intended to be used as an aid in determining the scope of the claimed subject matter.

### BRIEF DESCRIPTION OF THE SEVERAL VIEWS OF THE DRAWING

In the accompanying drawings, which form a part of the specification and are to be read in conjunction therewith in which like reference numerals are used to indicate like or similar parts in the various views:

FIG. 1 is a schematic diagram of a system for detecting a location of a joint center in accordance with one embodiment of the present invention;

FIG. 2 is a schematic diagram of a system for detecting a location of a joint center in accordance with one embodiment of the present invention;

FIG. 3 is a flow diagram of a digital image segmentation method illustrating steps carried out in accordance with an embodiment of the present invention;

FIG. 4 is a flow diagram illustrating steps of a method for creating and validating a deep neural network algorithm in accordance with one embodiment of the present invention;

FIG. 5 is a flow diagram illustrating a method to identify joint center coordinates to develop and administer a treatment plan, according to one embodiment of the present invention;

FIG. 6 illustrates an initial segmentation model of a human subject in accordance with one embodiment of the present invention;

FIG. 7 illustrates a segmentation model of a human subject in accordance with one embodiment of the present invention;

FIG. 8 illustrates a segmentation model of a human subject in accordance with one embodiment of the present invention;

FIG. 9 illustrates a segmentation model of a human subject in accordance with one embodiment of the present invention; and

FIG. 10 illustrates a further segmentation model of a human subject in accordance with one embodiment of the present invention.

### DETAILED DESCRIPTION OF THE INVENTION

Various embodiments of the present invention are described and shown in the accompanying materials, descriptions, instructions, and drawings. For purposes of clarity in illustrating the characteristics of the present invention, proportional relationships of the elements in the images have not necessarily been maintained. It will be appreciated that the images are simply provided as examples as part of case study summaries.

The following detailed description of the invention references specific embodiments in which the invention can be practiced. The embodiments are intended to describe aspects of the invention in sufficient detail to enable those skilled in the art to practice the invention. Other embodiments can be utilized, and changes can be made without departing from the scope of the present invention. The present invention is defined by the appended claims and the description is, therefore, not to be taken in a limiting sense and shall not limit the scope of equivalents to which such claims are entitled.

One aspect of the present invention is directed generally to a system and method of digital image segmentation and image processing for assessing one or more visual hulls and determining a segmentation algorithm appropriate to segment a targeted anatomical structure in order to efficiently and accurately identify the joint center(s) of the targeted anatomical structure.

In one embodiment, the segmentation of a digital image may be composed of digital representations of one or more objects or shapes. The digital representation of an object is often described herein in terms of identifying and manipulating the objects. Such manipulations are virtual manipulations, which in some non-limiting embodiments, can be accomplished in the memory, processor, controller, or other hardware of a networked system, as described herein.

Referring to the figures, the present invention relates to a system and process for detecting a location of one or more joint centers and target anatomical structures by utilizing advanced digital image segmentation in 3D motion capture visual hulls. Embodiments of the present invention provide multiple artificial intelligence-based visual hull segmentation methods, including multiple deep learning and neural network-based visual hull segmentation methods. The visual hull segmentation methods may be represented by the multiple layers or nodes inside the deep neural network. Embodiments of the present invention also provide a system for autonomous artificial intelligence-based digital image segmentation. In such embodiments, a trained advanced training module provided in the form of an intelligent artificial agent may perform detection and recognition of a plurality of segmentation tasks and intelligent automated selection and application of one or more segmentation algorithms.

It will be appreciated that the present invention may be utilized in objectively assessing visual hulls detecting from images of healthy subjects, as well as subjects who have sustained an injury, are undergoing rehabilitation or rehabilitation, are recovering from a surgical procedure, have a change in physical condition, or other circumstance where assessment may be appropriate, including but not limited to a clinical assessment. As such, the present invention can be implemented to objectively identify one or more characteristics of a visual hull (e.g., a target anatomical structure), identify an appropriate segmentation algorithm trained for a particular characteristic, and apply the segmentation algorithm. Additionally, the present invention can be implemented to objectively track and compare a subject's longitudinal skeletal tracking based on an objectively updated database of normative references updated based on the population data that has been validated by accurate segmentation of the digital images.

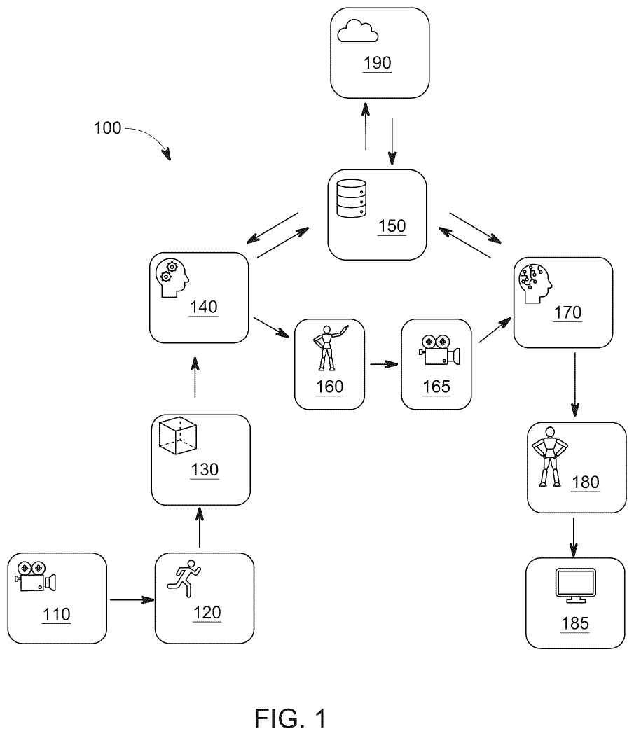

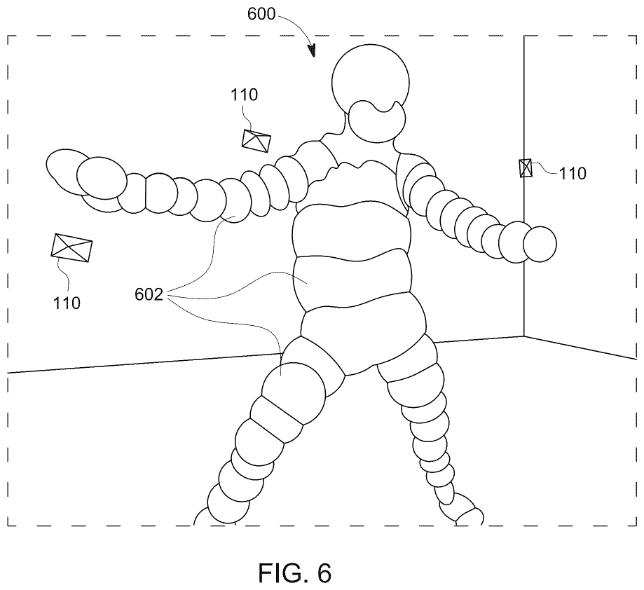

FIG. 1 illustrates a schematic diagram of a digital image processing system 100 in accordance with one embodiment of the present invention. As shown in FIG. 1, the digital image processing system 100 may include an image capture device 110 for collecting motion data 120 of a human subject 600 (see FIG. 6), a visual hull 130, one or more artificial intelligence models 140, a data store 150, an initial segmentation model 160, a functional movement capture device 165, one or more DNN algorithms 170, an updated segmentation model 180, and a computing device 185. In some embodiments, one or more components of the system 100 may operatively communicate with or otherwise be connected to a network 190.

In an alternative embodiment, the system 100 may include more than one image capture device 110. In at least one embodiment, the more than one image capture devices 110 can communicate with one another to provide a synced motion capture system. In various embodiments, the one or more image capture devices 110 can refer to a camera, image capture device, scanning device, multi-view video camera, or other sensing devices. In one embodiment, the one or more image capture devices 110 may include an image sensor system and/or an image data capture system. In one embodiment, the one or more image data capture devices 110 may include a camera configured to obtain image data within a field of view. In one non-limiting example, the one or more image capture devices 110 may be configured to capture and/or retrieve the motion data 120, provided in the form of image files of image data from a subject located within the boundaries of the system 100. The term “motion data” as used herein can include but is not limited to kinematic data, kinetic data, and similar and can also include data associated with an image, including still images. Also, it will be recognized by one skilled in the art that where kinematic data and/or kinetic data are used throughout the present disclosure, the application that other types of motion data are contemplated within the scope of the embodiments described herein.

In some embodiments, the motion data 120 can be transformed, or similar, through a digital image creation process. In some embodiments, the digital image creation process may include image transfer from a camera or other image capture device 110 to a workstation, including but not limited to the computing device 185. In some embodiments, other digital image processing techniques can be implemented at the computing device 185 or other workstation. In some embodiments, the digital image processing techniques can include feedback, manipulation, or other communication with the motion data 120. In some embodiments, the digital image processing techniques can include generating a 3D skeletal or skeleton construction. In some embodiments, the 3D skeletal construction data can include raw video data and/or biovision hierarchical data (BVH). The 3D skeletal construction can be saved as the motion data 120 or otherwise processed as a component or aspect of the image data, in some embodiments. In some embodiments, the 3D skeletal construction data can be saved to the data store 150, as described in more detail below. In some embodiments, the digital image processing techniques can include generating or detecting a visual hull 130 associated with the captured motion data 120.

The visual hull 130 segmentation generally includes the detection of boundaries of one or more target anatomical structures, including but not limited to arms, hands, legs, feet, torso, and the head of a human subject. The system can generate a visual hull 130, including a 3D reconstruction of the detected boundaries of the target anatomical structures. In at least some embodiments, the visual hull 130 represents an approximation of a shape of individual target anatomical structures based on one more image processing techniques and the system can output the approximation of one or more shapes of the target anatomical structures in the visual hull 130.

The motion data 120 and visual hull 130 can be analyzed using one or more advanced training modules 230, including but not limited to the one or more artificial intelligence models 140 and/or the DNN algorithm 170. In certain embodiments, data elements, characteristics, or other types of parameters can be extracted from the motion data 120 and/or the visual hull 130 and analyzed using one or more advanced training modules 230 to determine a context for the visual hull 130 and select an initial segmentation algorithm. In some embodiments, the system may select an artificial intelligence model 140 based, at least in part, on the context of the visual hull. In some embodiments, the system can design and/or iteratively train one or more of the advanced training modules 230 for a target anatomical structure, and/or for a parameter, a characteristic, or feature thereof. In some embodiments, the artificial intelligence model 140 can be provided in the form of a machine learning system, a deep learning system, a neural network system, one or more statistical models, or other processing models.

The motion data 120 and extracted kinetic data (not shown) can be stored in the one or more data stores 150. The information received or collected by the digital image processing system 100 can be stored in the one or more data stores 150. In at least one embodiment, the one or more data stores 150 may include a local database and a normative database. In some embodiments, the normative database can include data related to, including a normative data model, which can include the one or more regression models, distribution curve, or similar evaluation data as part of the objective ranking process described herein. In some embodiments, the local database can include session data, wherein the session data is related to a motion capture session for a particular user. In some embodiments, the session data can include motion data, image data, video data, and other data captured by the digital image processing system 100 during a session. In this example, the session can be determined by a session start or a session initialization and a session end or a session termination. In some embodiments, the session start/initialization can be triggered by user input on a user interface, by adding a parameter or tag to the session data, or automatically when a user is detected in the field of view of the motion capture system and/or image capture devices 110. In some embodiments, the session start/initialization can include a request to the one or more image capture devices 110 to capture motion data 120 in response to the request. In some embodiments, the session end/termination can be triggered by user input on a user interface, including but not limited to the computing device 185 by adding a parameter or tag to the session data, or automatically when the user is detected to leave the field of view of the motion capture system.

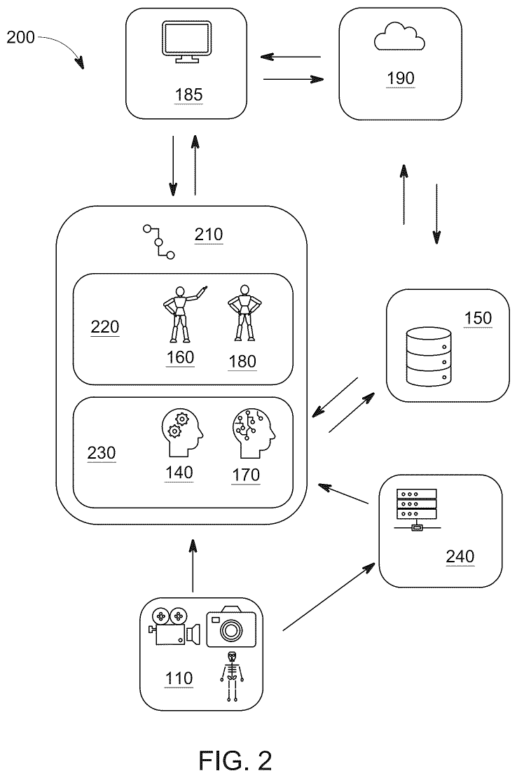

In some embodiments, the normative database can be provided in the form of the population reference data 240 (see FIG. 2). In some embodiments, the population reference data 240 can include the local database information. In some embodiments, the population reference data 240 and the one or more data stores 150 can be integrated into a single data model, or similar database. In some embodiments, the one or more data stores 150 and/or the population reference data 240 can be provided in the form of a memory unit, processor, elastic cache system, cloud storage, or similar.

Returning to FIG. 1, the detected visual hull 130 is analyzed by the one or more artificial intelligence models to apply an initial segmentation algorithm (not shown) to generate an initial segmentation model 160. The initial segmentation model 160 identifies an initial set of joint center coordinates of the human subject based on the visual hull 130 evaluated by the initial segmentation algorithm, as further described below.

A functional movement capture device 165 is used to record motion data 120 related to the initial segmentation model 160. In some embodiments, the functional movement capture device 165 can be provided in the form of the image capture device 110, multiple image capture devices 110, or a standalone component of the motion capture system. The functional movement capture device 165 is provided in the form of a multi-view camera in some embodiments.

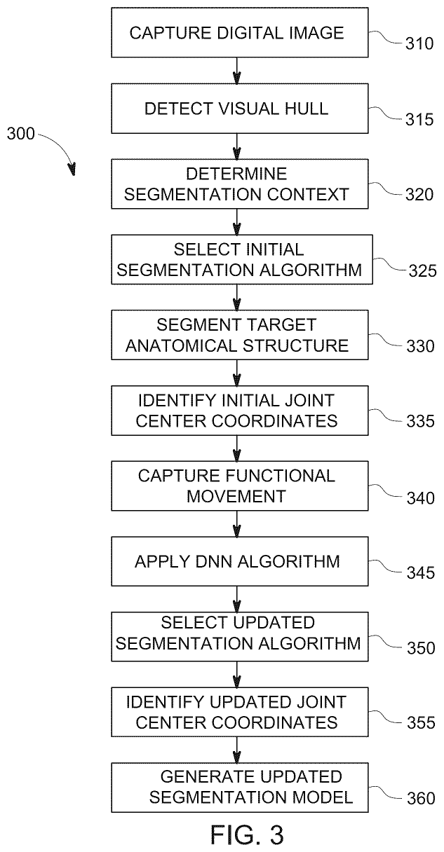

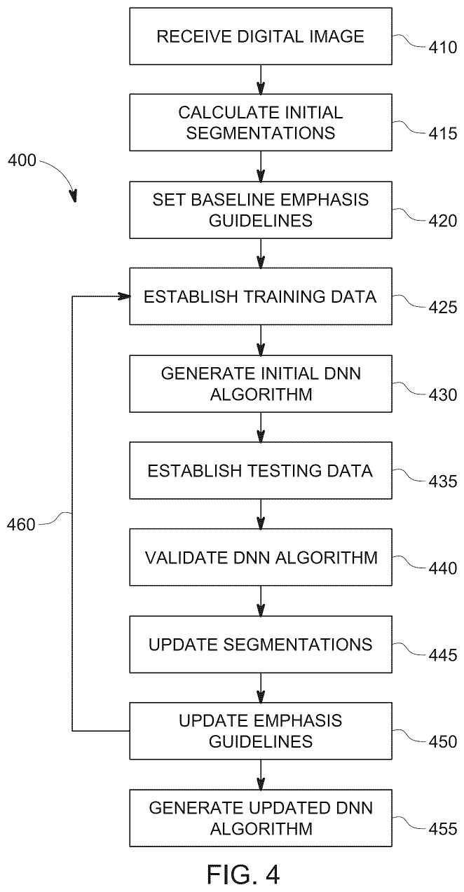

The deep neural network (“DNN”) algorithm 170 is applied to the image data received from the functional movement capture device to automatically select an updated visual hull segmentation algorithm and generate an updated segmentation model 180, including an updated set of joint center coordinates, as described in more detail in connection with FIGS. 3 and 4. The updated segmentation model 180 can be generated on a computing device 185.

In some embodiments, the digital image processing system 100 can also include or communicate with a computing device 185 or computing environment. In some embodiments, the computing device 185 or computing environment can be provided in the form of one or more computers server banks, computer banks, a desktop computer, a laptop computer, a cellular telephone, a tablet, a phablet, a notebook computer, a distributed system, a gaming console (e.g., Xbox, Play Station, Wii), a watch, a pair of glasses, a key fob, a radio frequency identification (RFID) tag, an earpiece, a scanner, a television, a dongle, a camera, a wristband, a wearable item, a kiosk, an input terminal, a server, a server network, a blade, a gateway, a switch, a processing device, a processing entity, a set-top box, a relay, a router, a network access point, a base station, any other device configured to perform the functions, operations, and/or processes described herein, or any combination thereof. Such computing devices 185 can be located in a single installation or may be distributed among many different geographical locations. In another embodiment, a controller, processor, or similar, may be used to implement aspects of FIGS. 1 and 2 or otherwise execute program instructions related to the system functions and processes described herein.

In some embodiments, the computing device 185 can be provided in the form of a communications interface of the digital image processing system 100 and/or the joint center detection model 210. In some embodiments, the communications interface can be designed to communicate with various system components, including on or more external computing devices and/or networks, including communication over the network 190. In some embodiments, the communications interface is capable of communicating data, content, and/or any other information, that can be transmitted, received, operated on, processed, displayed, stored, and similar. Communication via the communications interface may be executed using any wired data transmission protocol, or any other wireless protocol.

In some embodiments, the devices, system components, and aspects of FIGS. 1 and 2 can communicate directly with one another over the network 190. The network 190 includes, for example, the Internet, intranets, extranets, wide area networks (“WANs”), local area networks (“LANs”), wired networks, a coaxial cable data communication network, an optical fiber network, a direct wired serial communication connection (e.g., USB), wireless networks, such as a WiFi network, a radio communication network, a cellular data communication network (e.g., 4G, 5G, LTE, etc.), a direct wireless communication connection (e.g., Bluetooth, NFC, etc.), or other suitable networks, or any combination of two or more such networks. For example, such networks can include satellite networks, cable networks, Ethernet networks, and other types of networks. In some embodiments, the network may be a private network (e.g., a private LAN), a public network (e.g., the internet), or a combination of private and/or public networks.

In some embodiments, the system can further include a memory unit. In some embodiments, the memory unit is embedded in the computing device 185, although other system components discussed herein can include a memory unit. A memory unit can comprise volatile or non-volatile memory to not only provide space to execute program instructions, algorithms, or the advanced training modules 230 described herein, but to provide the space to store the instructions, data, and other information. In embodiments, volatile memory can include random access memory (RAM), dynamic random-access memory (DRAM), or static random-access memory (SRAM), for example. In embodiments, non-volatile memory can include read-only memory, flash memory, ferroelectric RAM, hard disk, floppy disk, magnetic tape, or optical disc storage, for example. The foregoing lists in no way limit the type of memory that can be used, as these embodiments are given only by way of example and are not intended to limit the scope of the invention.

In at least one embodiment, the system can further include a processor provided in the form of a microcontroller, controller, or other control device, wherein the control device is designed to control the logic of the system and execute programmable instructions to complete aspects of the processes of the system 100 as described herein. In some embodiments, the processor can be incorporated into the computing device 185, although other system components discussed herein can include one or more of a processor and/or control device.

FIG. 2 illustrates a schematic diagram of a motion analysis system 200 of the digital image processing system 100, wherein the motion analysis system 200 can further include a joint center detection model 210. The joint center detection model 210 can include the one or more segmentation models 220 and the one or more advanced training modules 230. The one or more segmentation models 220 can further include the initial segmentation model 160 and the updated segmentation model 180. The one or more advanced training modules 230 can further include the artificial intelligence model 140 and the DNN algorithm 170. It will be appreciated by one skilled in the art that although an initial segmentation model 160 and an updated segmentation model 180 are discussed herein, the one or more segmentation models 220 can include a plurality of segmentation models. Further, it will be appreciated that the one or more advanced training modules 230 can include a plurality of algorithms, artificial intelligence models, deep learning models, or similar, and are not limited to the artificial intelligence model 140 and the DNN algorithm 170 described herein.

In certain embodiments, the one or more advanced training modules 230 can include machine learning, artificial intelligence, deep learning, neural networks, one or more statistical models, other processing models, other modeling and analysis techniques, or a combination thereof. In certain embodiments.

In some embodiments, the motion analysis system 200 can execute the joint center detection model 210 to evaluate motion data 120 received by the one or more image capture devices 110 to objectively determine the joint center(s) for a human subject and generate one or more segmentation models 220, as described in more detail in connection with FIGS. 3-10. In some embodiments, the joint center detection model 210 can include a user interface provided in the form of the computing device 185, a communication interface to transmit information to the user interface, or a combination thereof. One or more components of the motion analysis system 200 can communicate via a network 190 connection, as described in connection with FIG. 1.

The advanced training modules 230 may be created using training data including image data and motion data from population reference data 240, in one non-limiting example, each sample training set has pre-determined values for one or more parameters, characteristics, and/or features of the target anatomical structure. In some embodiments, the advanced training modules 230 can include a normative data model and can use training data stored in the population reference data 240. The data stored in the population reference data 240 can also include a plurality of data elements, including population data comprising images, image files, image data, videos, video files, video data, calibration data, parameter data, validation data, threshold data, etc. In some embodiments, the population reference data 240 can be provided in the form of a digital library. The population reference data 240 can include data elements from a plurality of human subjects, including but not limited to images and visual hull segmentation models, and can further include historical data related to a particular human subject.

The one or more data stores 150 can include a plurality of segmentation algorithms, which can be selected by the one or more advanced training modules 230, as described in connection with the processes discussed below. The one or more data stores 150 can further include a plurality of segmentation algorithms which can be further trained and/or optimized according to one or more target anatomical structures, features, characteristics, or parameters in order to improve the joint center detection model 210. In one embodiment, the one or more data stores 150 can store various items, including training data, such as images and visual hull segmentation models including data captured previously from other human subjects.

In some embodiments, the normative data model and/or normative database of the population reference data 240 and/or included in the one or more data stores 150, may communicate over the network 190 to accomplish one or more cloud data processing tasks, including storing, transmitting, transforming, and processing the data in a cloud data storage platform (not shown). In some embodiments, the cloud data storage may include the motion data, the image data, the session data, segmentation models, report data generated from the output of the system, and/or population reference data 240 of one or more of the data types described herein.

In one embodiment, a user interface of the digital image processing system 100 and/or the motion analysis system 200 can be a computing device 185, which can be in communication with one or more input or output devices that are capable of receiving and/or generating a display of the one or more segmentation models 220, a report, and other analysis parameters, as described in more detail in connection with FIGS. 3-5.

In some embodiments, the computing device 185 can include one or more input and/or output devices, which can be configured to receive inputs into and/or any outputs from the computing device 185 or other components of the joint center detection model 210 (see FIG. 2) or the digital image processing system 100 overall. Embodiments of input devices can include but are not limited to, a keyboard, a mouse, a touchscreen display, a touch-sensitive pad, a motion input device, a movement input device, an audio input, a pointing device input, a joystick input, a keypad input, peripheral device, foot switch, or similar input device. Embodiments of output devices can include but are not limited to, an audio output device, a video output, a display device, a motion output device, a movement output device, a printing device, or a similar output device. In some embodiments, the user interface includes hardware that can be designed to communicate with one or more input devices and/or output devices via wired and/or wireless connections.

FIG. 3 illustrates an advanced visual hull segmentation method 300 in accordance with one embodiment of the invention. A digital image of a human subject is first received from image capture device 110 at step 310. A visual hull is then detected at step 315 and the system determines a segmentation context for the visual hull at step 320. The artificial intelligence model 140 selects an initial segmentation algorithm at step 325, which is executed by the system and applied to the visual hull to segment a target anatomical structure at step 325. An initial segmentation model 160 is generated at step 335, wherein the initial segmentation model identifies an initial set of joint center coordinates. The initial segmentation model of the human subject is based, at least in part, on the initial segmentation algorithm applied to the visual hull, as further described below. Upon initialization, a default skeleton can be produced. Once the human subject begins to move, the functional movement is observed. At step 340, functional movement is captured by the functional movement capture device 165. The DNN algorithm 170 is applied to the captured functional movement at step 315, and the system uses the output of the DNN algorithm 170 to determine an updated segmentation algorithm at step 350. The DNN algorithm 170 may optimize the body segments of the human subject by altering the location of the joint centers using one or more of the visual hull segmentation algorithms. The one or more visual hull segmentation algorithms are stored in the one or more data stores 150, in one non-limiting embodiment.

The updated segmentation algorithm is applied to the visual hull 130 to identify an updated set of joint center coordinates at set 355, which is then used by the system to generate an updated segmentation model 180 at step 360. The updated segmentation model 180 includes the updates set of joint center coordinates. The updated joint center coordinates are determined based on the initial segmentation model 160, along with the DNN algorithm 170 and the updated segmentation algorithm at step 350. The updated segmentation algorithm improves upon the initial segmentation algorithm by placing the joint center coordinates in a location that more accurately represents the actual location of the joint centers of the human subject.

FIG. 4 illustrates the process 400 for creating and validating DNN algorithm 170 in accordance with one embodiment of the invention. In one embodiment of the present invention, a digital image is received which includes a visual hull 130 of a human subject 600. A current segmentation context is automatically determined based on the visual hull 130 and at least one segmentation algorithm is automatically selected from a plurality of segmentation algorithms based on the current segmentation context. A target anatomical structure is segmented for the body using the selected at least one segmentation algorithm. Segmentation processes may make an educated guess based off an anthropometric standard, and be designed to achieve centroid alignment between gaussian spheres. This novel approach uses an automation selection process implemented by one or more advanced training modules 230 of the system to select one or more segmentation algorithms based on optimizations, where in the optimizations can be based on training procedures, emphasis guidelines, target anatomical structures, features, characteristics, or other parameters.

At step 410, the DNN algorithm 170 receives one or more digital images from the image capture device 110. At step 415, initial segmentations are calculated using the initial segmentation algorithm. At step 410, the initial segmentations are received by the DNN algorithm 170 and set as the baseline emphasis guidelines for the human subject 600. When used throughout the present disclosure, “emphasis guidelines” can include ground truth measurements for the human subject 600 and can also include weights, ranks, or other metrics associated with iteratively training the DNN algorithm 170 and/or one of the advanced training modules 230 to improve the accuracy and relevance of the generated results.

Training data is created at step 425, including training data received or obtained from the population reference data 240, data store 150, and/or a digital library, which in some embodiments can be stored in one or more of the population reference data 240 or the data store 150. The training data includes a video library of one or more human subjects and their associated motion data 120, including the human subjects moving with the standard offering. In some embodiments, the training data can further include other randomly reviewed video feeds and associated data elements.

At step 430, an initial DNN algorithm is created. In some embodiments, the initial DNN algorithm may be referred to as the DNN candidate model and can be provided in the form of the raw DNN algorithm before training occurs. Testing data, incorporated into a testing database in some embodiments, is created at step 435 and used to validate the initial DNN algorithm at step 440. to produce the updated DNN algorithm 104 at step 310. The testing database can include a collection of unsolvable complex cases, by the initial DNN algorithm, and is used to test the updated DNN algorithm using the training data. The testing database is able to confirm the improvement of the joint center locations based on updated segmentations at step 445 and the emphasis guidelines for the DNN algorithm updated at step 450 based on confirmation of the skeletal tracking and the updated DNN algorithm with the new emphasis guidelines is generated at step 455 and used to provide updated joint center coordinates to generate the updated segmentation model 180. The validation process 400 can be iteratively repeated at least at step 460 to provide a feedback loop for continuous training and improved outcomes.

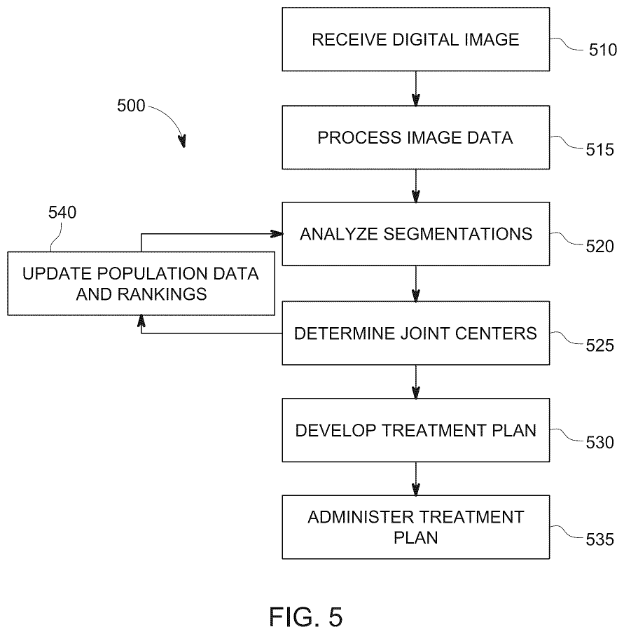

FIG. 5 illustrates an example of joint center coordinate detection associated with a clinical diagnostic and treatment process 500 in accordance with one embodiment of the present invention. FIG. 5 illustrates how improved joint center coordinate results improve the downstream function of kinematics and kinetics, resulting in more accurate databases, including the population reference data 240, for clinical reference support. At step 510, the system receives a digital image and the associated image data is processed at 515. The segmentations can be analyzed at step 520 using one or more segmentation algorithms selected by the one or more advanced training modules 230. At step 525, the system can determine updated joint center coordinates and update population data and rankings at step 540, including those in the population reference data 240. The updated joint center coordinates can further be generated and output to a computing device 185, or a similar user interface, for a clinician to access and use to develop a treatment plan for the human subject 600 at step 530. In some embodiments, the clinician may be provided in the form of a physical therapist, athletic trainer, medical personnel, physician, or similar professional with an understanding of kinesthetics and anatomy. At step 535, a clinician can administer the treatment plan generated by the process 500.

In some embodiments, the joint center detection model 210 processes the image data in order to generate updated joint center coordinates and improve joint center localization. The joint center detection model 210 produces more accurate and consistent localization, thus resulting in improved repeatability and reproducible joint center identification. Increased consistency leads to improved kinematic, kinetic, and anthropometric variables and improves population reference data 240, including at step 540. For example, when a shoulder joint center is moved, the angle of the bone traveling to the elbow is altered, and the angle will produce an alternative kinematic joint excursion. The different ranges determined for a particular target anatomical structure will alter a distribution curve for a population and alter the normative ranking and reference associated with the target anatomical structure in the population reference data 240. For instance, an altered shoulder joint angle may move the joint range (excursion) from 160-185 degrees (mean=172) to 150-193 (mean=177). With improved population reference data 240, the updated joint center coordinates determined at step 525 and the clinical treatment development at step 530 are also improved. Clinical decisions in rehabilitation are based on measurable data, and such data needs to meet a repeatable criterion that is clinically relevant. Consistency in the joint center location accuracy in detecting joint center coordinates will allow for appropriate progression and longitudinal tracking of a human subject's function. Further, a clinical decision and development of a treatment plan using the present invention can be supported by an objective normative reference and validated data that is referenced to a database of quality data, including but not limited to the population reference data 240.

FIGS. 6-8 further illustrate the processes described above, including but not limited to, the selection of the initial and updated segmentation algorithms and the generation of the initial segmentation model 160 and the updated segmentation model 180, which are created using the one or more advanced training modules 230.

As illustrated in FIG. 6, the initial segmentation algorithm utilizes gaussian sums to create proxy spheres 602 that fill the visual hull 130 of a human subject 600 in 3D space. The human subject 600 may be made up of several proxy spheres 602, that represent body segments of the human subject 600, as demonstrated in FIG. 6.

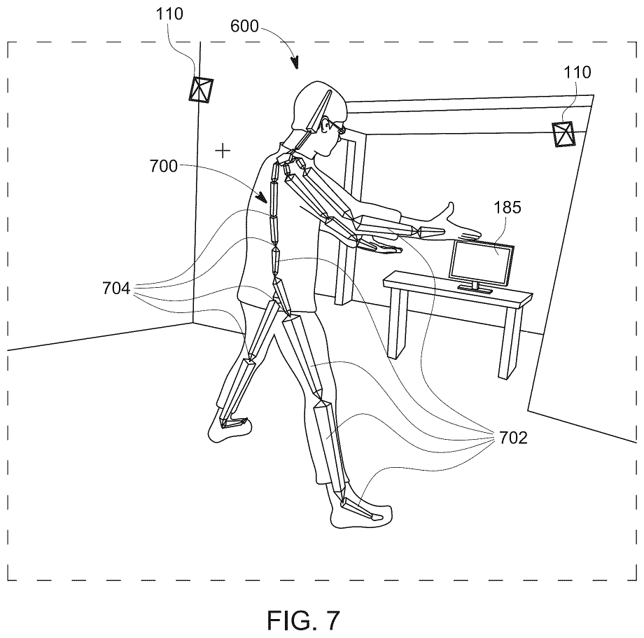

As shown in FIG. 7, the proxy spheres 602 are combined with vectors traveling through their centroids to create a kinetic skeleton 700, resulting in skeletal segments 702 and segment interactions or joint centers 704. The vectors change trajectory, in magnitude and direction, based on the updated joint center coordinates. The initial segmentation algorithm creates an estimation of proxy sphere's 602 location. The DNN algorithm 170 is then employed to determine the specific location of proxy sphere's 602 location from the visual hull 130 using the updated segmentation algorithm, and the system further determines the specific location of skeletal segments 702 of human subject 600. Through the use of one or more DNN algorithms 170, skeletal segments 702 and thus joint centers 704 of human subject 600 are located on a more accurate and consistent basis throughout tracking.

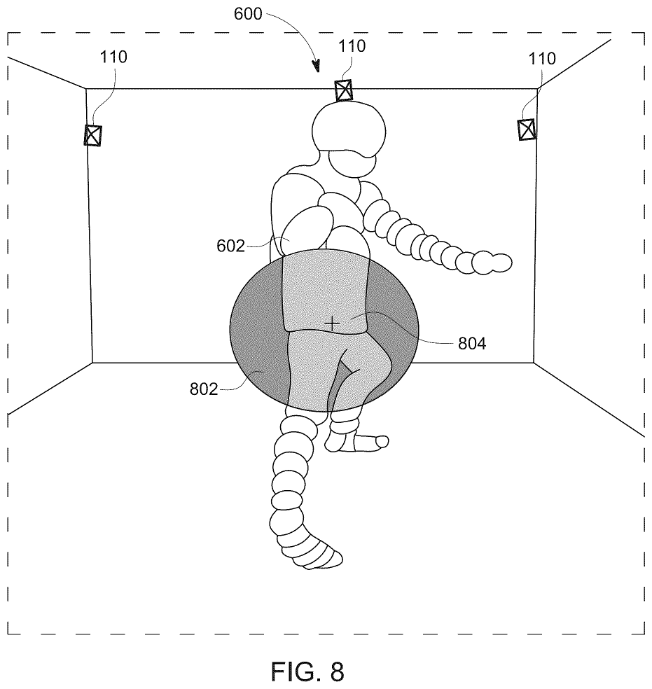

Further, as shown in FIG. 8, one or more energy functions may be calculated from the gaussian distribution. Through color analysis of an image, for example, a surrounding environment or background 802 can be separated from one or more body segments 804 of the human subject 600. For instance, if a human subject 600 is wearing pants of a solid color, identifying the joint location of the knee becomes complicated. In the image of the human subject 600 shown in FIG. 8, the energy function(s) directly correlate to the color differences in the image. Through the use of energy functions, the body segments 805 and joint centers 704 (see FIG. 7) of the human subject 600 are able to be identified.

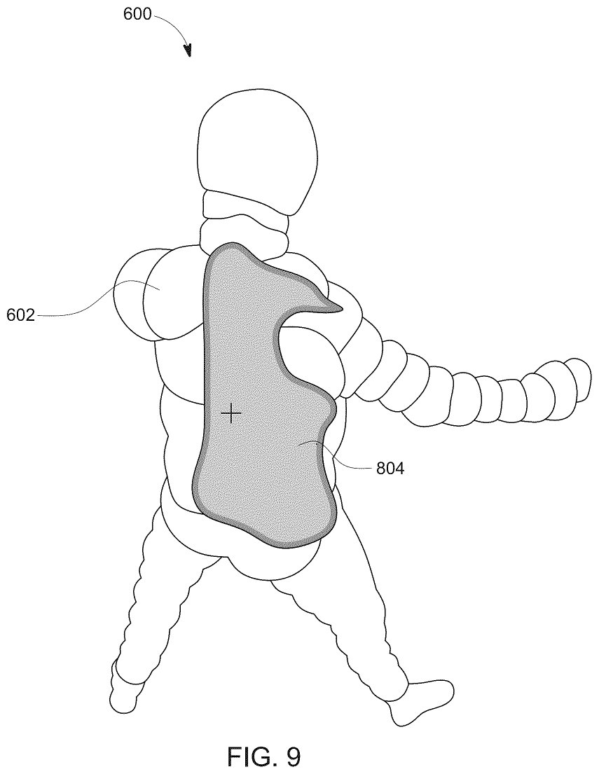

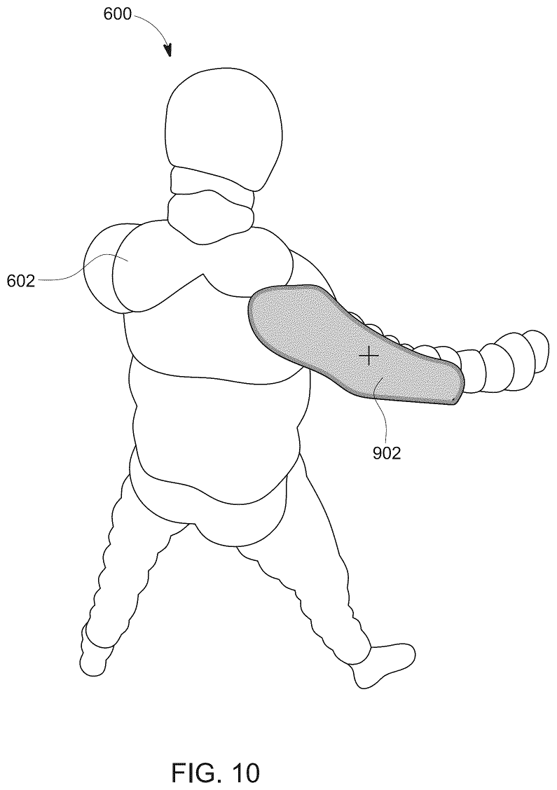

FIGS. 9 and 10 illustrate visual representations of the updated segmentation algorithm and associated updated segmentation model 180 produced from DNN algorithm 170. As shown in FIGS. 9 and 10, a body segment 804 and an arm segment 902 are more specifically identified. The updated segmentation algorithm creates a more optimized segmentation output when compared to proxy spheres 602 (see FIG. 6). The use of such optimized segmentation in turn improves the joint center localization. Improved segmentation will result in improved proxy locations, allowing for an updated optimization and calculation of an updated joint center.

Accordingly, instead of a user having to utilize a generic segmentation technique to perform a particular segmentation task, the one or more advanced training modules 230 can be used to intelligently and autonomously select and apply an optimal segmentation algorithm from the one or more segmentation algorithms or combination of segmentation algorithms for the visual hull segmentation task. This more robust model for joint center detection and tracking makes the progressive longitudinal tracking of human movement more sufficient. With enough data collected and stored in the population reference data 240, the application of population normative ranges can be applied with less variance.

In one embodiment of the present invention, a system for advanced visual hull segmentation using one more advanced training modules 230 to perform intelligent automated recognition of segmentation tasks and automatically select and apply one or more segmentation algorithms based on an evaluation and analysis of the motion data 120 and associated visual hull 130. This allows the one or more advanced training modules 230 to be applied to intelligently perform various different segmentation tasks, including segmentation of different target anatomical structures, and segmentation in different 3D motion capture visual hulls. The segmentation tasks can improve the body segmentation and proxy sphere locations (described in more detail in connection with FIGS. 6-10), resulting in more defined borders of the segments and proxies. The advanced training modules 230 can intelligently select one or a combination of segmentation algorithms from a plurality of segmentation algorithms to perform visual hull segmentation for various anatomical objects and target anatomical structures. The one or more advanced training modules 230 are configured to automatically select a segmentation algorithm(s) trained or otherwise optimized based on a target anatomical structure, feature, characteristics, or similar parameter. The selection of one segmentation algorithm over another can drastically change the optimization, and, in turn, change the joint center locations relative to the proxy spheres.

In another non-limiting example, the system and methods of the present invention can be used to track a human subject's rehabilitation progress, as compared to population reference data 240, to objectively determine if prescribed rehabilitation measures are being completed.

These examples are in no way exhaustive and are meant to illustrate the wide range of industries, applications, and embodiments.

Various embodiments of systems, devices, and methods have been described herein. These embodiments are given only by way of example and are not intended to limit the scope of the invention. It should be appreciated, moreover, that the various features of the embodiments that have been described may be combined in various ways to produce numerous additional embodiments. Moreover, while various materials, dimensions, shapes, configurations, locations, etc. have been described for use with disclosed embodiments, others besides those disclosed may be utilized without exceeding the scope of the invention.

In some embodiments, the system or components thereof can comprise or include various modules or controllers, each of which is constructed, programmed, configured, or otherwise adapted, to autonomously carry out a function or set of functions. The term “controller” as used herein can include a real-world device, component, or arrangement of components implemented using hardware, or as a combination of hardware and software, such as by a microprocessor system and a set of program instructions that adapt the controller to implement the particular functionality, which (while being executed) transform the microprocessor system into a special-purpose device. A controller can also be implemented as a combination of the two, with certain functions facilitated by hardware alone, and other functions facilitated by a combination of hardware and software. In certain implementations, at least a portion, and in some cases, all, of a controller can be executed on the processor(s) of one or more computing platforms that are made up of hardware (e.g., one or more processors, data storage devices such as memory or drive storage, input/output facilities such as network interface devices, video devices, keyboard, mouse or touchscreen devices, etc.) that execute an operating system, system programs, and application programs, while also implementing the controller using multitasking, multithreading, distributed (e.g., cluster, peer-peer, cloud, etc.) processing where appropriate or other such techniques. Accordingly, each controller can be realized in a variety of physically realizable configurations, and should generally not be limited to any particular implementation exemplified herein, unless such limitations are expressly called out. In addition, a controller can itself be composed of more than one sub-controllers, each of which can be regarded as a controller in its own right. Moreover, in the embodiments described herein, each of the various controllers corresponds to a defined autonomous functionality; however, it should be understood that in other contemplated embodiments, each functionality can be distributed to more than one controller. Likewise, in other contemplated embodiments, multiple defined functionalities may be implemented by a single controller that performs those multiple functions, possibly alongside other functions, or distributed differently among a set of controllers than specifically illustrated in the examples herein.

Certain embodiments of the present disclosure provide software comprising a series of instructions executable by a processor to carry out a method as described herein. Certain embodiments of the present disclosure provide software for use with a computer comprising a processor and memory for storing the software, the software comprising a series of instructions executable by the processor to carry out a method as described herein.

The constructions described above and illustrated in the drawings are presented by way of example only and are not intended to limit the concepts and principles of the present invention. Thus, there has been shown, and described several embodiments of a novel invention. As is evident from the foregoing description, certain aspects of the present invention are not limited by the particular details of the examples illustrated herein, and it is therefore contemplated that other modifications and applications, or equivalents thereof, will occur to those skilled in the art. The terms “having” and “including” and similar terms as used in the foregoing specification are used in the sense of “optional” or “may include” and not as “required”. Many changes, modifications, variations, and other uses and applications of the present construction will, however, become apparent to those skilled in the art after considering the specification and the accompanying drawings. All such changes, modifications, variations, and other uses and applications which do not depart from the spirit and scope of the invention are deemed to be covered by the invention which is limited only by the claims which follow.

What is claimed is:

1. An image segmentation method for analyzing digital image data and detecting a location of a joint center of a human subject, the method comprising the steps of:
capturing a digital image using an image capture device;
detecting a visual hull segmentation of the digital image, the visual hull segmentation including one or more proxy spheres;
selecting an initial segmentation algorithm based on a context of the visual hull segmentation;
identifying a set of initial joint center coordinates using the initial segmentation algorithm;
capturing a functional movement of the human subject;
applying a deep neural network algorithm to select an updated segmentation algorithm;
identifying a set of updated joint center coordinates using the updated segmentation algorithm; and
generating an updated segmentation model based on the set of updated joint center coordinates.

2. The method of claim 1, wherein the digital image is a video.

3. The method of claim 1, where in the image capture device is a 3D markerless motion capture device.

4. The method of claim 1, wherein the proxy spheres represent body segments of the human subject.

5. The method of claim 1, wherein the set of initial joint center coordinates are determined based on the visual hull segmentation.

6. The method of claim 1, wherein the deep neural network algorithm utilizes the functional movement of the human subject and at least one visual hull segmentation algorithm to select the updated segmentation algorithm.

7. The method of claim 1, wherein the set of updated joint center coordinates of the human subject identified using the updated segmentation model are an improved representation of the human subject's joint center locations compared to the set of initial joint center coordinates of the human subject identified using the initial segmentation algorithm.

8. The method of claim 1, further comprising:
training a segmentation algorithm based on a target anatomical structure; and
segmenting the target anatomical structure of the human subject using the segmentation algorithm trained for the target anatomical structure.

9. An image segmentation method for detecting a location of a joint center of a human subject, the method comprising the steps of:
obtaining a digital image from an image capture device;
detecting a visual hull segmentation of the digital image, wherein the visual hull segmentation includes one or more proxy spheres;
selecting an initial segmentation algorithm using baseline emphasis guidelines based on a segmentation context of the visual hull segmentation;
identifying a set of initial joint center coordinates using the initial segmentation algorithm;
generating an initial segmentation model based on the initial joint center coordinates;
obtaining a functional movement of the human subject;
applying a deep neural network algorithm based on the functional movement;
validating the deep neural network algorithm;
updating the baseline emphasis guidelines based on the validating step and saving as updated emphasis guidelines;
selecting an updated segmentation algorithm using the updated emphasis guidelines;
identifying a set of updated joint center coordinates using the updated segmentation algorithm and the deep neural network algorithm; and
generating an updated segmentation model based on the set of updated joint center coordinates.

10. The method of claim 9, wherein the digital image is a 3D image.

11. The method of claim 9, wherein the image capture device is a markerless motion capture device.

12. The method of claim 9, where in the set of initial joint center coordinates are determined based on the visual hull segmentation.

13. The method of claim 9, wherein the proxy spheres represent body segments of the human subject.

14. The method of claim 9, wherein the updated segmentation model can identify distinct body segments of the human subject.

15. The method of claim 9, wherein validating the deep neural network algorithm further comprises the steps of:
receiving image data from the image capture device;
calculating segmentations from the initial segmentation algorithm to establish the baseline emphasis guidelines;
creating training data including a digital library of human subjects and associated functional movement data with skeletal tracking; and
confirming the deep neural network algorithm selects a segmentation algorithm that accurately identifies a joint center localization.

16. A method for detecting a location of a joint center, the method comprising the steps of:
obtaining a digital image of a human subject from an image capture device;
detecting a visual hull segmentation of the human subject, the visual hull segmentation including one or more proxy spheres;
calculating an initial segmentation algorithm of the human subject, the initial segmentation algorithm including a set of initial joint center coordinates of the human subject;
obtaining a functional movement of the human subject from the image capture device; and
utilizing a deep neural network algorithm to calculate an updated segmentation algorithm of the human subject, the updated segmentation model including a set of updated joint center coordinates of the human subject.

17. The method of claim 16, wherein the proxy spheres represent body segments of the human subject.

18. The method of claim 16, wherein the set of initial joint center coordinates are determined based on the visual hull segmentation.

19. The method of claim 16, wherein the deep neural network algorithm utilizes the functional movement of the human subject and a visual hull segmentation algorithm to calculate the updated segmentation algorithm of the human subject.

20. The method of claim 16, further comprising the steps of:
generating an initial segmentation model of the human subject based on the initial joint center coordinates of the human subject; and
generating an updated segmentation model of the human subject based on the updated joint center coordinates of the human subject.
